(19) United States
(12) Patent Application Publication
(10) Pub. No.: US 2025/0253592 A1
(43) Pub. Date: Aug. 7, 2025

(54) Connector Assembly and Electrical Connector Thereof

(71) Applicants: Dongguan Tarng Yu Electronics Co., Ltd., Dongguan City (CN); Tarng Yu Enterprise co., ltd., New Taipei City (TW)

(72) Inventors: YING-CHUNG CHEN, New Taipei City (TW); MU-JUNG HUANG, New Taipei City (TW)

(21) Appl. No.: 19/037,090

(22) Filed: Jan. 25, 2025

(30) Foreign Application Priority Data
Feb. 2, 2024 (TW) 113104320

(51) Int. Cl. H01R 13/6588; H01R 13/24; H01R 13/6471

(52) U.S. Cl. CPC H01R 13/6588; H01R 13/2442; H01R 13/6471

(57) ABSTRACT

A connector assembly and electrical connector thereof, wherein the electrical connector is capable of mating with a mating conductive component, the electrical connector comprises a conductive plastic base, a conductive metal shielding component, and a signal terminal, wherein the signal terminal is capable of mating with the mating conductive component to transmit signals, and the conductive plastic base and the conductive metal shielding component are capable of providing shielding to the signal terminal to reduce the degree of interference with the signal transmission of the signal terminal, thereby meeting the signal transmission requirements of the electrical connector.

### CROSS-REFERENCE TO RELATED APPLICATIONS

This application claims the priority of Republic of China Patent Application No. 113104320 filed on Feb. 2, 2024, in the State Intellectual Property Office of the R.O.C., the disclosure of which is incorporated herein by reference.

### BACKGROUND OF THE INVENTION

### Field of the Invention

This application relates to the technical field of electronic devices, and more specifically, to a connector assembly and electrical connector thereof that can provide shielding for signal terminals to meet signal transmission requirements.

### Descriptions of the Related Art

In recent years, electrical connectors comprise been widely applied to various electronic devices. However, with the special demands and advancements in electronic devices, the need for signal transmission in electrical connectors has been increasing day by day. Existing electrical connectors, limited by inadequate shielding effects due to mechanical design, often experience interference during signal transmission. This interference leads to issues such as attenuation and distortion in the signal transmission process, making it difficult for electrical connectors to meet signal transmission requirements. The interference may comprise, for example, EMI (Electromagnetic Interference) or crosstalk noise interference.

Therefore, how to reduce the interference experienced by electrical connectors during the signal transmission process is a pressing problem that those skilled in the art urgently need to solve.

### SUMMARY OF THE INVENTION

In view of the drawbacks of the prior art mentioned above, the present application provides an electrical connector, the electrical connector comprising: a conductive plastic base, the conductive plastic base comprising a first major conductive plastic base signal terminal non-mating side shielding structure and a second major conductive plastic base signal terminal non-mating side shielding structure, wherein a major conductive plastic base signal terminal root shielding space is formed between the first major conductive plastic base signal terminal non-mating side shielding structure and the second major conductive plastic base signal terminal non-mating side shielding structure, and a major conductive plastic base signal terminal mating shielding space is formed between the first major conductive plastic base signal terminal non-mating side shielding structure and the second major conductive plastic base signal terminal non-mating side shielding structure; a conductive metal shielding component, the conductive metal shielding component equipped with the conductive plastic base, the conductive metal shielding component comprising a major conductive metal shielding component signal terminal mating side shielding structure, and the major conductive metal shielding component signal terminal mating side shielding structure entering the major conductive plastic base signal terminal root shielding space; and a major signal terminal module, the major signal terminal module comprising a major signal terminal and a major signal terminal insulation core, wherein the major signal terminal comprises a major signal terminal root structure and a major signal terminal mating structure, the major signal terminal root structure providing support for the major signal terminal mating structure, and the major signal terminal insulation core respectively position the major signal terminal and the conductive plastic base, such that the major signal terminal root structure enters the major conductive plastic base signal terminal root shielding space, allowing the first major conductive plastic base signal terminal non-mating side shielding structure and the second major conductive plastic base signal terminal non-mating side shielding structure to respectively provide shielding for the major signal terminal root structure on a major non-mating side of the major signal terminal, and allowing the major conductive metal shielding component signal terminal mating side shielding structure provides shielding for the major signal terminal root structure on a major mating side of the major signal terminal, enabling the major signal terminal mating structure to enter the major conductive plastic base signal terminal mating shielding space, allowing the first major conductive plastic base signal terminal non-mating side shielding structure and the second major conductive plastic base signal terminal non-mating side shielding structure to respectively provide shielding for the major signal terminal mating structure on the major non-mating side.

Preferably, the electrical connector said above, wherein the conductive plastic base further comprises a major conductive plastic base signal terminal penetrating passage, the major conductive plastic base signal terminal penetrating passage being located between the first major conductive plastic base signal terminal non-mating side shielding structure and the second major conductive plastic base signal terminal non-mating side shielding structure to allow the major signal terminal to pass through, thereby preventing the conductive plastic base from interfering with the major signal terminal.

Preferably, the electrical connector said above, wherein the major conductive metal shielding component signal terminal mating side shielding structure provides shielding for the major conductive plastic base signal terminal penetrating passage on the major mating side.

Preferably, the electrical connector said above, further comprising a major grounding terminal module, the major grounding terminal module comprising a first major grounding terminal and a second major grounding terminal, wherein the first major grounding terminal comprises a first major grounding terminal root structure and a first major grounding terminal mating structure, and the first major grounding terminal root structure provides support for the first major grounding terminal mating structure, and the second major grounding terminal comprises a second major grounding terminal root structure and a second major grounding terminal mating structure, and the second major grounding terminal root structure provides support for the second major grounding terminal mating structure, and the first major grounding terminal and the second major grounding terminal are respectively positioned by the conductive plastic base, such that the first major grounding terminal root structure and the second major grounding terminal root structure enter the major conductive plastic base signal terminal root shielding space, allowing the first major grounding terminal root structure and the second major grounding terminal root structure to respectively provide shielding for the major signal terminal root structure on the major non-mating side, and the first major grounding terminal mating structure and the second major grounding terminal mating structure respectively enter the major conductive plastic base signal terminal mating shielding space, allowing the first major grounding terminal mating structure and the second major grounding terminal mating structure to respectively provide shielding for the major signal terminal mating structure on the major non-mating side.

Preferably, the electrical connector said above, wherein the first major grounding terminal is positioned by the first major conductive plastic base signal terminal non-mating side shielding structure, and the second major grounding terminal is positioned by the second major conductive plastic base signal terminal non-mating side shielding structure.

Preferably, the electrical connector said above, wherein the conductive metal shielding component further comprises a first major conductive metal shielding component grounding terminal penetrating passage and a second major conductive metal shielding component grounding terminal penetrating passage, the first major conductive metal shielding component grounding terminal penetrating passage allowing the first major grounding terminal to pass through, and the second major conductive metal shielding component grounding terminal penetrating passage allowing the second major grounding terminal to pass through, thereby preventing the conductive metal shielding component from interfering with the first major grounding terminal and the second major grounding terminal.

Preferably, the electrical connector said above, wherein the conductive metal shielding component further comprises a conductive metal shielding component body, the conductive metal shielding component body spanning across the major signal terminal and respectively positioning the first second major grounding terminal and the second major grounding terminal, enabling the conductive metal shielding component body to electrically connect the first major grounding terminal and the second major grounding terminal.

Preferably, the electrical connector said above, wherein the first major conductive plastic base signal terminal non-mating side shielding structure comprises a first major conductive plastic base grounding terminal penetrating passage, and the second major conductive plastic base signal terminal non-mating side shielding structure comprises a second major conductive plastic base grounding terminal penetrating passage, and the first major conductive plastic base grounding terminal penetrating passage allows the first major grounding terminal to pass through, and the second major conductive plastic base grounding terminal penetrating passage allows the second major grounding terminal to pass through, thereby preventing the first second major conductive plastic base signal terminal non-mating side shielding structure from interfering with the first major grounding terminal, and preventing the second major conductive plastic base signal terminal non-mating side shielding structure from interfering with the second major grounding terminal.

Preferably, the electrical connector said above, wherein the major signal terminal is projected on a major signal terminal projection plane, the projection of the first major grounding terminal root structure on the major signal terminal projection plane is in a first major grounding terminal root structure projection area, and the projection of the second major grounding terminal root structure on the major signal terminal projection plane is in a second major grounding terminal root structure projection area, and the major signal terminal root structure is projected in the first major grounding terminal root structure projection area and the second major grounding terminal root structure projection area; and the projection of the first major grounding terminal mating structure on the major signal terminal projection plane is in a first major grounding terminal mating structure projection area, and the projection of the second major grounding terminal mating structure on the major signal terminal projection plane is in a second major grounding terminal mating structure projection area, and the major signal terminal mating structure is projected in the first major grounding terminal mating structure projection area and the second major grounding terminal mating structure projection area.

Preferably, the electrical connector said above, further comprising a bridging conductive component, wherein the bridging conductive component comprises a bridging conductive component body, a first major bridging conductive component joining structure, and a second major bridging conductive component joining structure, the bridging conductive component being positioned by the conductive plastic base such that the bridging conductive component body spans across the major signal terminal, and the first major bridging conductive component joining structure is joined to the first major grounding terminal, and the second major bridging conductive component joining structure is joined to the second major grounding terminal, thereby the bridging conductive component body electrically connecting the first major grounding terminal and the second major grounding terminal.

Preferably, the electrical connector said above, wherein the conductive metal shielding component further comprises a conductive metal shielding component body, and the conductive metal shielding component body spans across the major signal terminal and is positioned by the bridging conductive component body, thereby electrically connecting the conductive metal shielding component body to the bridging conductive component body.

Preferably, the electrical connector said above, wherein the conductive plastic base further comprises a first minor conductive plastic base signal terminal non-mating side shielding structure and a second minor conductive plastic base signal terminal non-mating side shielding structure, wherein a minor conductive plastic base signal terminal root shielding space is provided between the first minor conductive plastic base signal terminal non-mating side shielding structure and the second minor conductive plastic base signal terminal non-mating side shielding structure, and a minor conductive plastic base signal terminal mating shielding space is provided between the first minor conductive plastic base signal terminal non-mating side shielding structure and the second minor conductive plastic base signal terminal non-mating side shielding structure; the conductive metal shielding component further comprises a minor conductive metal shielding component signal terminal mating side shielding structure, the minor conductive metal shielding component signal terminal mating side shielding structure entering the minor conductive plastic base signal terminal root shielding space; and the electrical connector further comprises: a minor signal terminal module, wherein the minor signal terminal module comprises a minor signal terminal and a minor signal terminal insulation core, the minor signal terminal comprising a minor signal terminal root structure and a minor signal terminal mating structure, the minor signal terminal root structure providing support for the minor signal terminal mating structure, and the minor signal terminal insulation core respectively positions the minor signal terminal and the conductive plastic base such that the minor signal terminal root structure enters the minor conductive plastic base signal terminal root shielding space, causing the first minor conductive plastic base signal terminal non-mating side shielding structure and the second minor conductive plastic base signal terminal non-mating side shielding structure to respectively provide shielding for the minor signal terminal root structure on a non-mating side of the minor signal terminal, and causing the minor conductive metal shielding component signal terminal mating side shielding structure to provide shielding for the minor signal terminal root structure on a minor mating side of the minor signal terminal, while also allowing the minor signal terminal mating structure to enter the minor conductive plastic base signal terminal mating shielding space, so that the first minor conductive plastic base signal terminal non-mating side shielding structure and the second minor conductive plastic base signal terminal non-mating side shielding structure respectively provide shielding for the minor signal terminal mating structure on the minor non-mating side.

Preferably, the electrical connector said above, wherein the conductive plastic base further comprises a minor conductive plastic base signal terminal penetrating passage, and the minor conductive plastic base signal terminal penetrating passage is located between the first minor conductive plastic base signal terminal non-mating side shielding structure and the second minor conductive plastic base signal terminal non-mating side shielding structure for the minor signal terminal to pass through, while preventing interference with the minor signal terminal by the conductive plastic base.

Preferably, the electrical connector said above, wherein the minor conductive metal shielding component signal terminal mating side shielding structure provides shielding for the minor conductive plastic base signal terminal penetrating passage on the minor mating side.

Preferably, the electrical connector said above, further comprising a minor grounding terminal module, wherein the minor grounding terminal module comprises a first minor grounding terminal and a second minor grounding terminal, the first minor grounding terminal comprising a first minor grounding terminal root structure and a first minor grounding terminal mating structure, the first minor grounding terminal root structure providing support for the first minor grounding terminal mating structure, the second minor grounding terminal comprising a second minor grounding terminal root structure and a second minor grounding terminal mating structure, the second minor grounding terminal root structure providing support for the second minor grounding terminal mating structure, and the first minor grounding terminal and the second minor grounding terminal being positioned by the conductive plastic base such that the first minor grounding terminal root structure and the second minor grounding terminal root structure respectively enter the minor conductive plastic base signal terminal root shielding space, thereby causing the first minor grounding terminal root structure and the second minor grounding terminal root structure to respectively provide shielding for the minor signal terminal root structure on the minor non-mating side, and causing the first minor grounding terminal mating structure and the second minor grounding terminal mating structure to respectively enter the minor conductive plastic base signal terminal mating shielding space, thereby causing the first minor grounding terminal mating structure and the second minor grounding terminal mating structure to respectively provide shielding for the minor signal terminal mating structure on the minor non-mating side.

Preferably, the electrical connector said above, wherein the first minor grounding terminal is positioned by the first minor conductive plastic base signal terminal non-mating side shielding structure and the second minor grounding terminal is positioned by the second minor conductive plastic base signal terminal non-mating side shielding structure.

Preferably, the electrical connector said above, wherein the conductive metal shielding component further comprises a first major conductive metal shielding component grounding terminal penetrating passage and a second major conductive metal shielding component grounding terminal penetrating passage, wherein the first major conductive metal shielding component grounding terminal penetrating passage is provided for the first grounding terminal to pass through, and the second major conductive metal shielding component grounding terminal penetrating passage is provided for the second grounding terminal to pass through, in order to prevent the conductive metal shielding component from interfering with the first grounding terminal and the second grounding terminal.

Preferably, the electrical connector said above, wherein the conductive metal shielding component further comprises a conductive metal shielding component body, wherein the conductive metal shielding component body spans across the minor signal terminal and respectively positions the first grounding terminal and the second grounding terminal, such that the conductive metal shielding component body electrically connects the first grounding terminal and the second grounding terminal.

Preferably, the electrical connector said above, wherein the first major conductive plastic base signal terminal non-mating side shielding structure comprises a first major conductive plastic base grounding terminal penetrating passage, and the second major conductive plastic base signal terminal non-mating side shielding structure comprises a second major conductive plastic base grounding terminal penetrating passage, wherein the first major conductive plastic base grounding terminal penetrating passage is provided for the first grounding terminal to pass through, and the second major conductive plastic base grounding terminal penetrating passage is provided for the second grounding terminal to pass through, in order to prevent the first major conductive plastic base signal terminal non-mating side shielding structure from interfering with the first grounding terminal, and to prevent the second major conductive plastic base signal terminal non-mating side shielding structure from interfering with the second grounding terminal.

Preferably, the electrical connector said above, wherein the minor grounding terminal is projected on a minor signal terminal projection plane, the projection of the first minor grounding terminal root structure on the minor signal terminal projection plane is in a first minor grounding terminal root structure projection area, and the projection of the second minor grounding terminal root structure on the minor signal terminal projection plane is in a second minor grounding terminal root structure projection area, and the minor signal terminal root structure is projected in the first minor grounding terminal root structure projection area and the second minor grounding terminal root structure projection area; and the projection of the first minor grounding terminal mating structure on the minor signal terminal projection plane is in a first minor grounding terminal mating structure projection area, and the projection of the second minor grounding terminal mating structure on the minor signal terminal projection plane is in a second minor grounding terminal mating structure projection area, and the minor signal terminal mating structure is projected in the first minor grounding terminal mating structure projection area and the second minor grounding terminal mating structure projection area.

Preferably, the electrical connector said above, further comprising a bridging conductive component, wherein the bridging conductive component comprises a bridging conductive component body, a first minor bridging conductive component joining structure, and a second minor bridging conductive component joining structure, the bridging conductive component being positioned by the conductive plastic base such that the bridging conductive component body spans across the minor signal terminal, and the first minor bridging conductive component joining structure is joined to the first minor grounding terminal, and the second minor bridging conductive component joining structure is joined to the second minor grounding terminal, thereby the bridging conductive component body electrically connecting the first minor grounding terminal and the second minor grounding terminal.

Preferably, the electrical connector said above, wherein the bridging conductive component body is located between the major signal terminal module and the minor signal terminal module.

Preferably, the electrical connector said above, wherein the conductive metal shielding component further comprises a conductive metal shielding component body, wherein the conductive metal shielding component body spans across the minor signal terminal module and is positioned by the bridging conductive component body, such that the conductive metal shielding component body electrically connects the bridging conductive component body.

Furthermore, this application further provides a connector assembly, the connector assembly comprising: the electrical connector said above; and a mating conductive component, the mating conductive component comprising a major mating conductive component signal terminal mating structure, wherein the mating conductive component is matable with the electrical connector, such that the major mating conductive component signal terminal mating structure mates with the major signal terminal mating structure in the major conductive plastic base signal terminal mating shielding space, wherein, when the mating conductive component mates with the electrical connector, the major mating conductive component signal terminal mating structure is located on the major mating side.

Preferably, the connector assembly said above, the connector assembly comprising: the electrical connector said above; and a mating conductive component, the mating conductive component comprising a major mating conductive component signal terminal mating structure and a minor mating conductive component signal terminal mating structure, wherein the mating conductive component is matable with the electrical connector, such that the major mating conductive component signal terminal mating structure mates with the major signal terminal mating structure in the major conductive plastic base signal terminal mating shielding space, and the minor mating conductive component signal terminal mating structure mates with the minor signal terminal mating structure in the minor conductive plastic base signal terminal mating shielding space, wherein, when the mating conductive component mates with the electrical connector, the major mating conductive component signal terminal mating structure is located on the major mating side of the major signal terminal, and the minor mating conductive component signal terminal mating structure is located on the minor mating side of the minor signal terminal.

Compared with the prior art, the present application provides a connector assembly and electrical connector thereof, wherein the electrical connector is capable of mating with a mating conductive component, the electrical connector comprises a conductive plastic base, a conductive metal shielding component, and a signal terminal, wherein the signal terminal is capable of mating with the mating conductive component to transmit signals, and the conductive plastic base and the conductive metal shielding component are capable of providing shielding to the signal terminal to reduce the degree of interference with the signal transmission of the signal terminal, thereby meeting the signal transmission requirements of the electrical connector.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic view of a connector assembly of the present application from a first perspective in an embodiment.

FIG. 2 is a three-dimensional schematic view of a connector assembly of the present application from a second perspective in an embodiment.

FIG. 3 is a three-dimensional schematic view of an electrical connector of the present application from a first perspective in an embodiment.

FIG. 4 is a three-dimensional schematic view of an electrical connector of the present application from a second perspective in an embodiment.

FIG. 5 is a three-dimensional schematic view of an electrical connector of the present application from a first perspective in an embodiment.

FIG. 6 is a three-dimensional schematic view of an electrical connector of the present application from a second perspective in an embodiment.

FIG. 7 is a top view schematic of an electrical connector of the present application in an embodiment.

FIG. 8 is a cross-sectional schematic view of a partial component of the electrical connector shown in FIG. 7, taken along line AA.

FIG. 9 is a front view schematic of an electrical connector of the present application in an embodiment.

FIG. 10 is a cross-sectional schematic view of a partial component of the electrical connector shown in FIG. 9, taken along line BB.

FIG. 11 is a cross-sectional schematic view of a partial component of the electrical connector shown in FIG. 9, taken along line CC.

FIG. 12 is a three-dimensional schematic view of a partial component of an electrical connector of the present application in an embodiment.

FIG. 13 is a top view schematic of a partial component of an electrical connector of the present application in an embodiment.

FIG. 14 is a front view schematic of a partial component of an electrical connector of the present application in an embodiment.

FIG. 15 is a three-dimensional schematic view of a conductive plastic base of the present application from a first perspective in an embodiment.

FIG. 16 is a three-dimensional schematic view of a conductive plastic base of the present application from a second perspective in an embodiment.

FIG. 17 is a three-dimensional schematic view of a partial component of an electrical connector of the present application in an embodiment.

FIG. 18 is a three-dimensional schematic view of a partial component of an electrical connector of the present application in an embodiment.

FIG. 19 is a three-dimensional schematic view of a partial component of an electrical connector of the present application in an embodiment.

FIG. 20 is a three-dimensional schematic view of a partial component of an electrical connector of the present application in an embodiment.

FIG. 21 is a three-dimensional schematic view of a partial component of an electrical connector of the present application in an embodiment.

FIG. 22 is a front view schematic of an electrical connector of the present application in an embodiment.

FIG. 23 is a cross-sectional schematic view of a partial component of the electrical connector shown in FIG. 22, taken along line DD.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Furthermore, in the following embodiments, structures or components with identical or similar functions will be denoted using the same symbols, and the descriptions of identical or equivalent technical features will be omitted to make the disclosed content more concise and easier to understand.

The present application provides at least one connector assembly and electrical connector thereof. The electrical connector is capable of mating with a mating conductive component. The electrical connector comprises a conductive plastic base, a conductive metal shielding component, and a signal terminal. The signal terminal is capable of mating with the mating conductive component to transmit signals. The conductive plastic base and the conductive metal shielding component are capable of providing shielding for the signal terminal to reduce the degree of interference with the signal transmission of the signal terminal, thereby meeting the signal transmission requirements of the electrical connector.

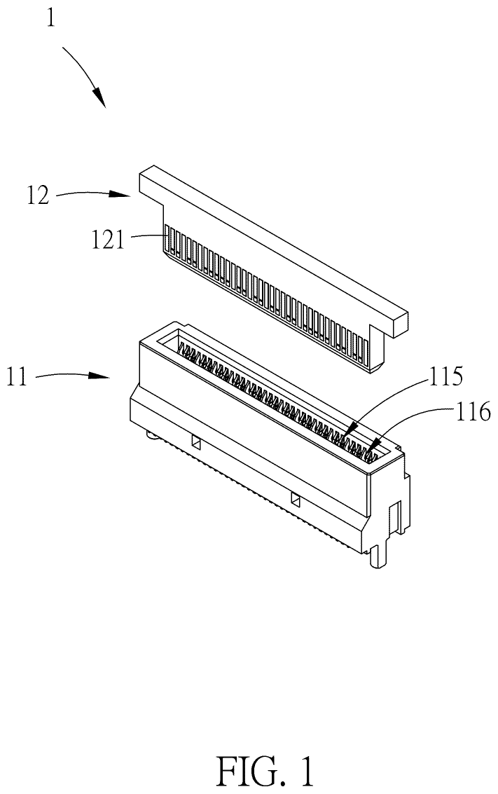

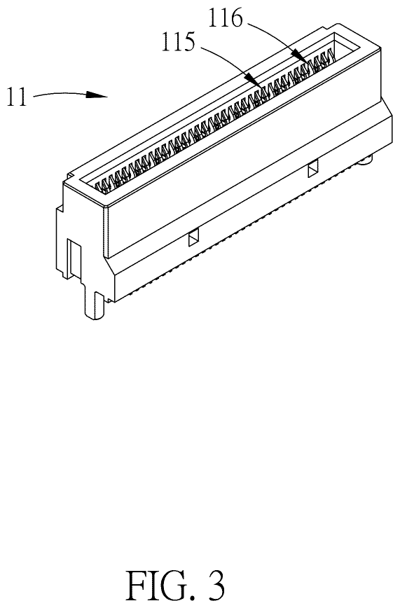

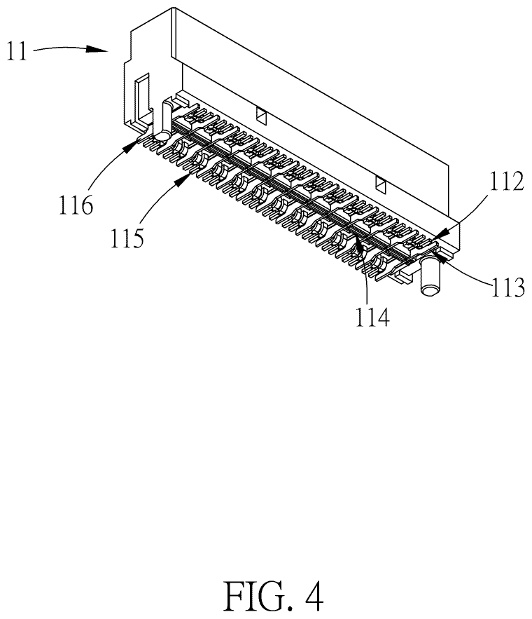

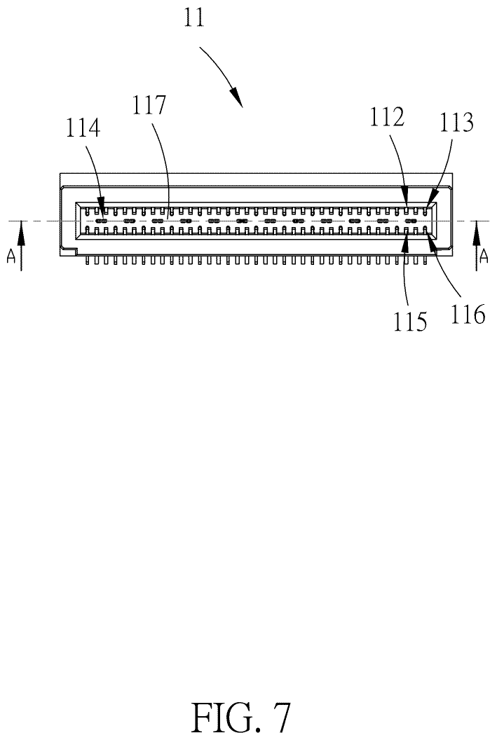

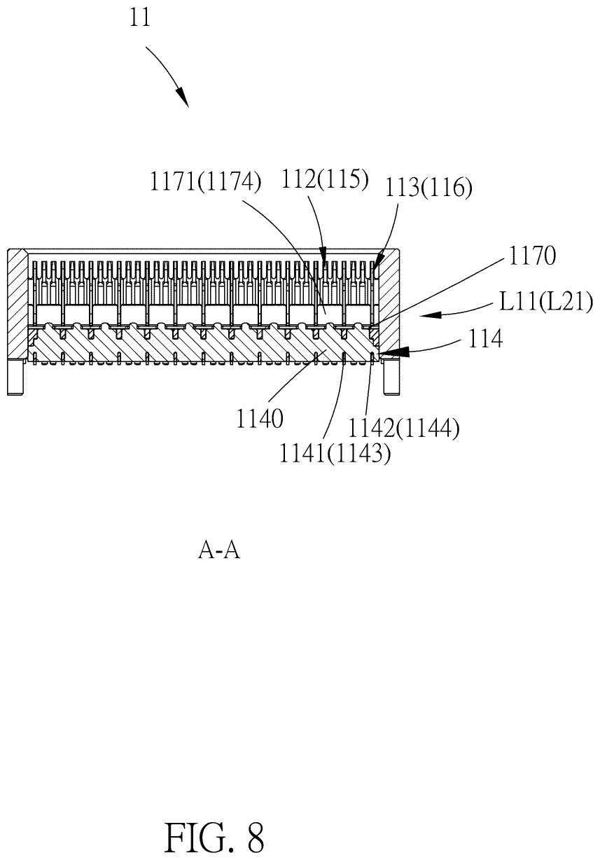

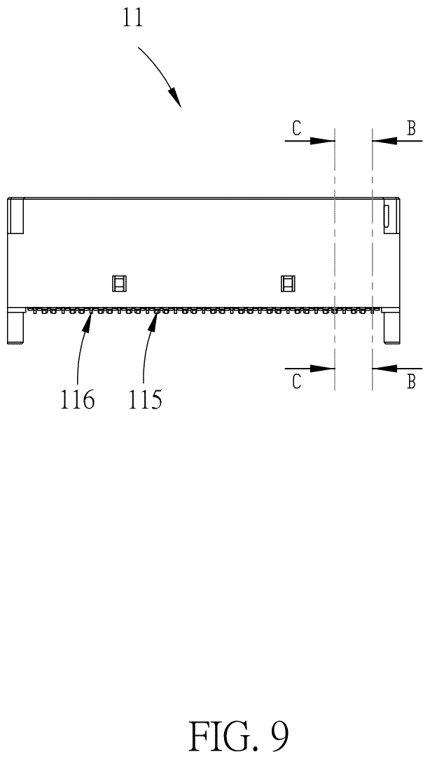

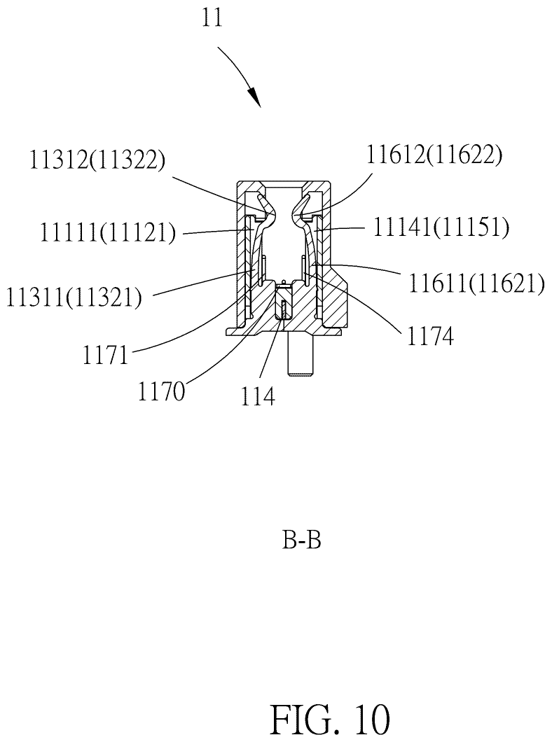

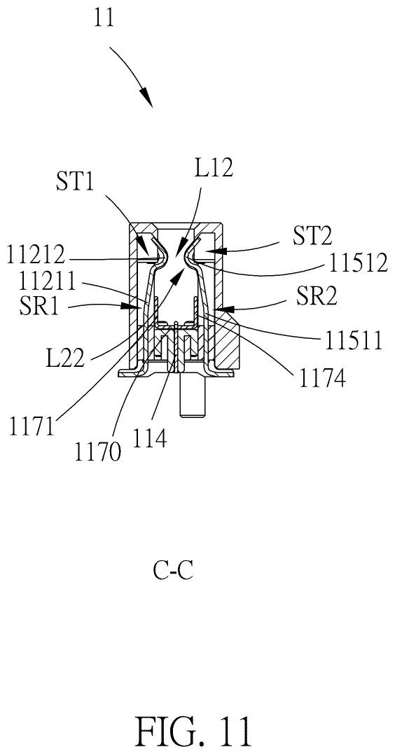

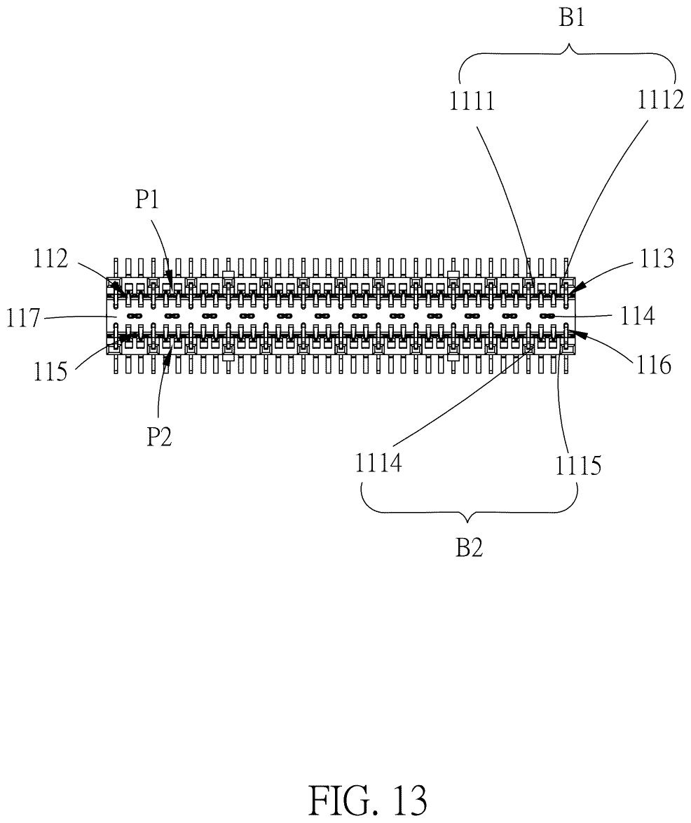

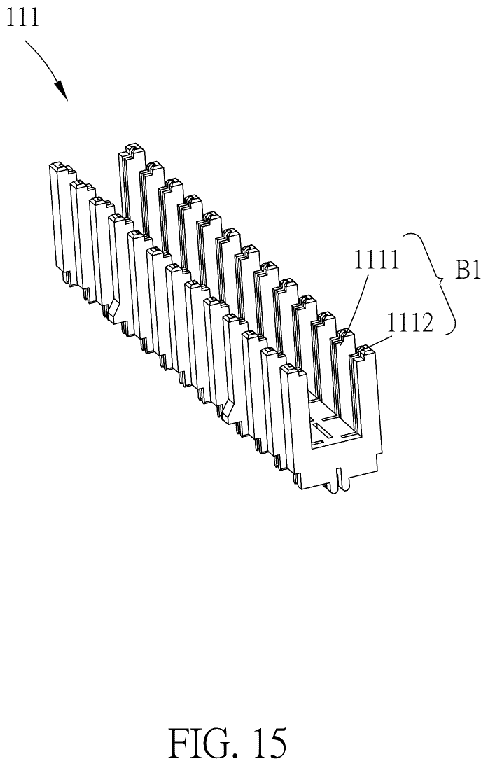

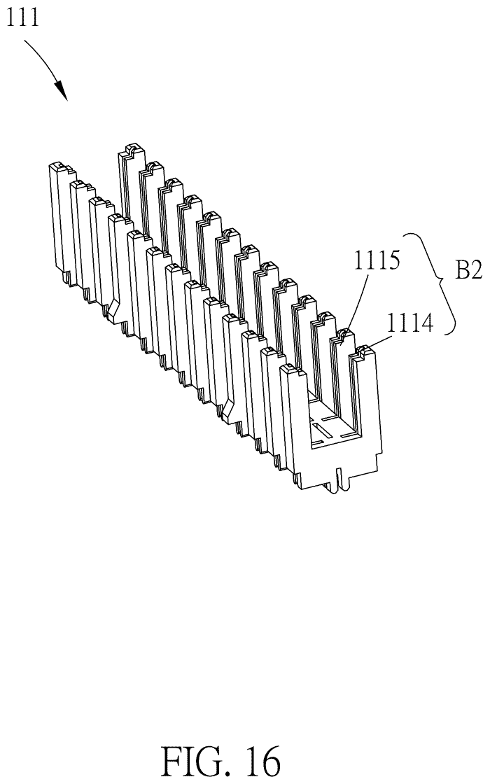

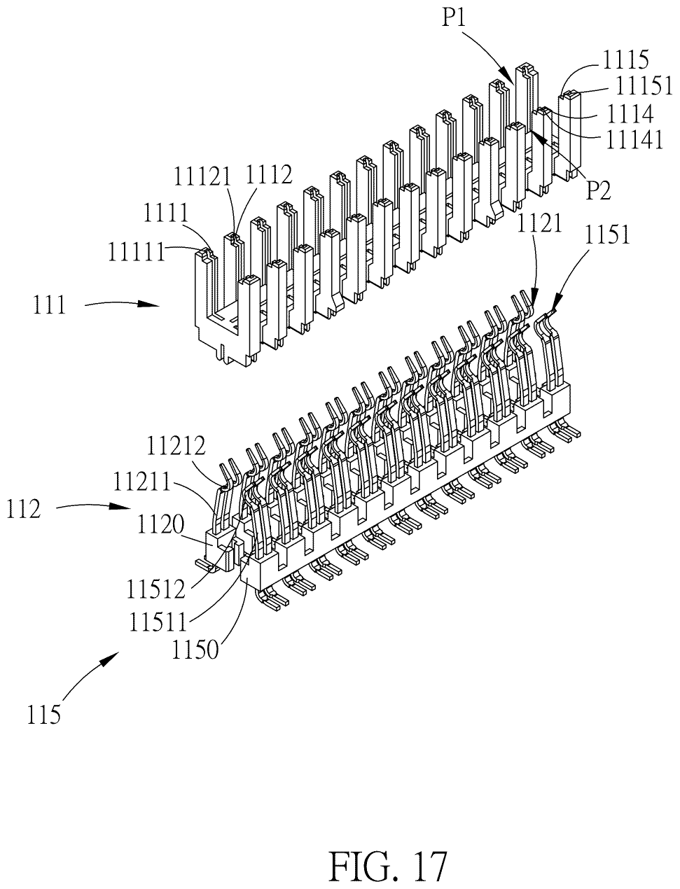

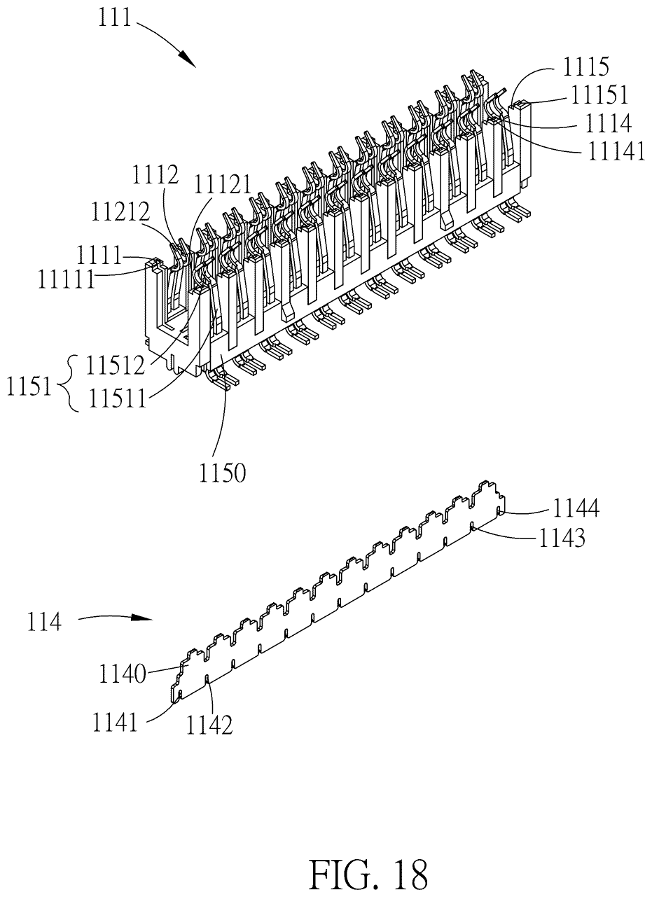

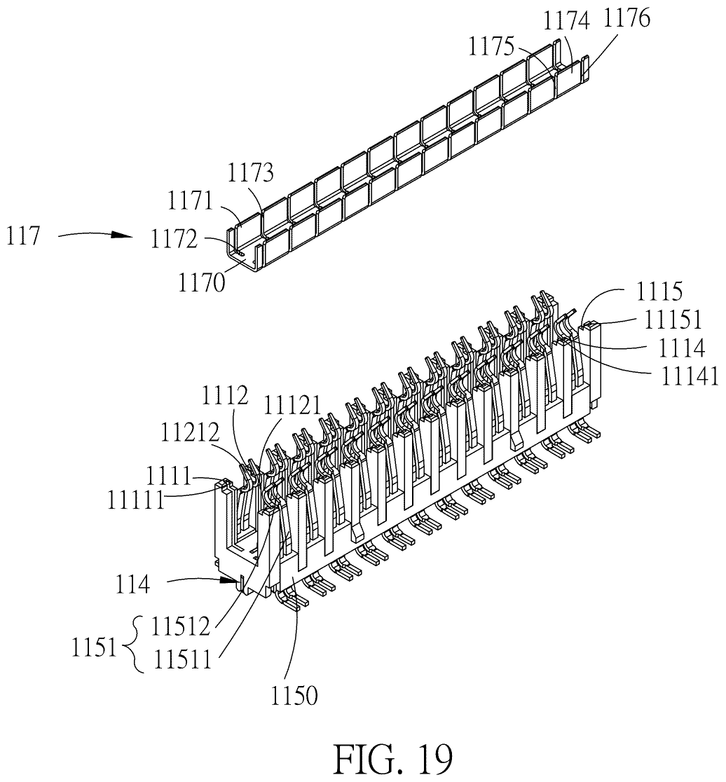

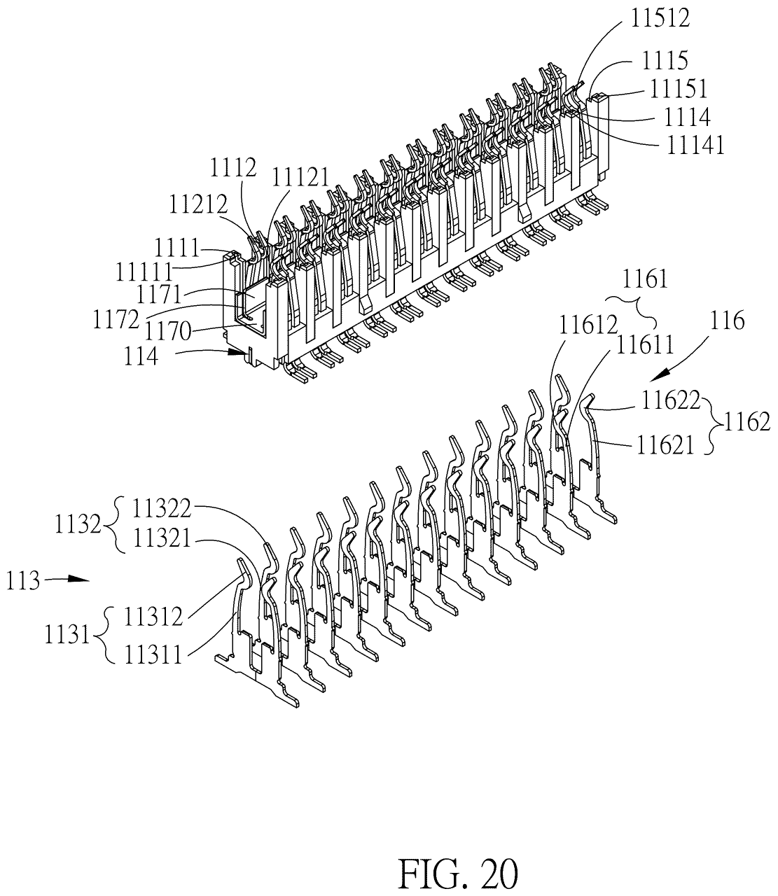

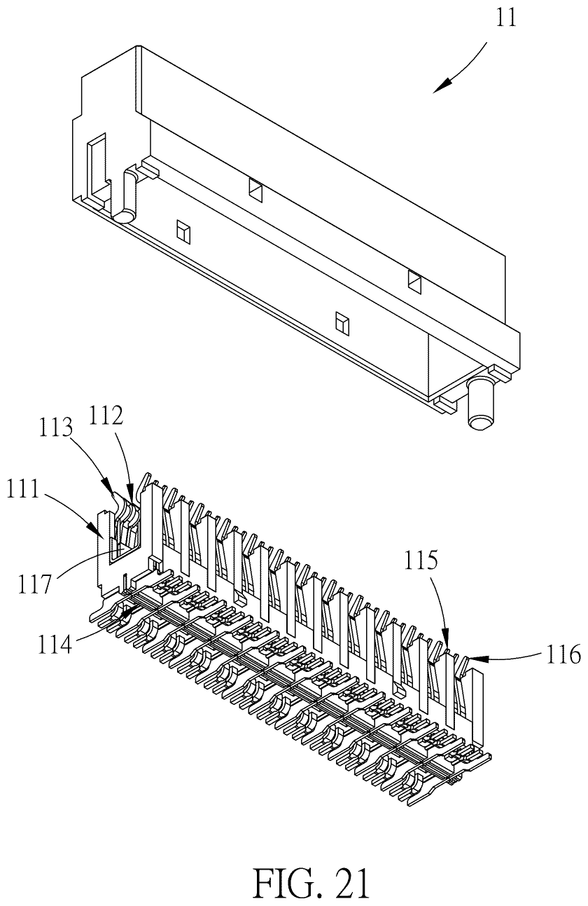

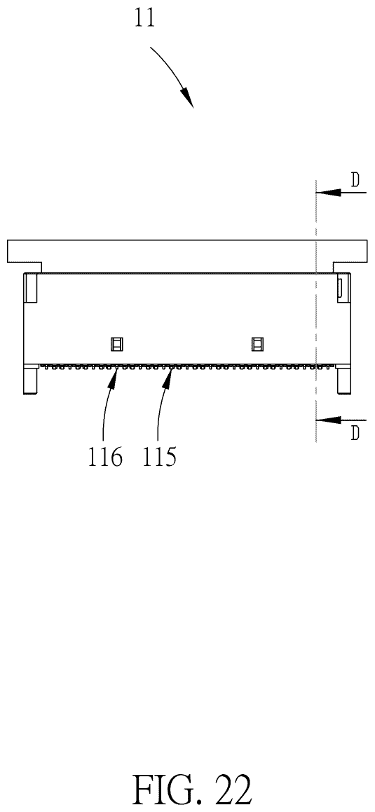

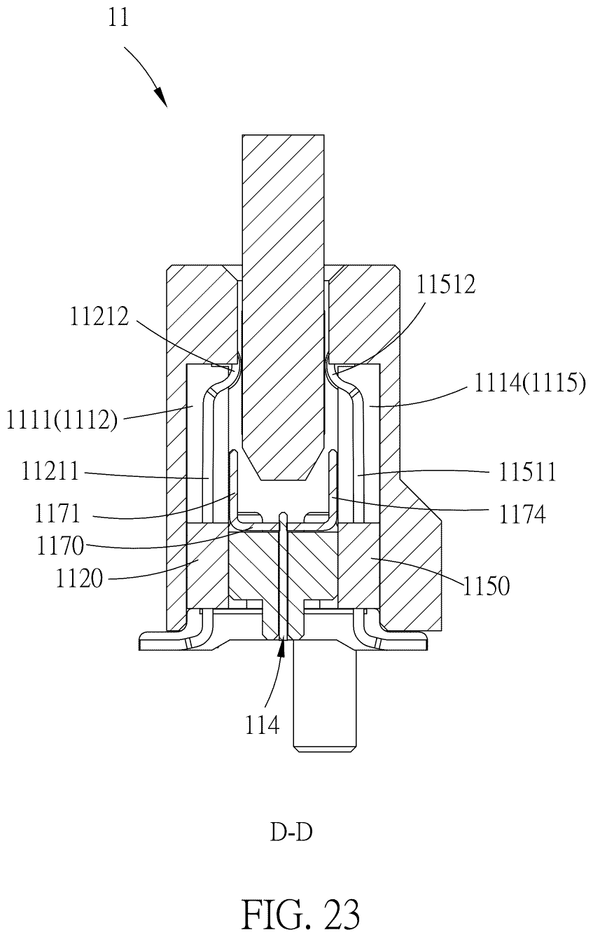

For a detailed description of the embodiments disclosed in the present application, please refer to FIGS. 1 to 23.

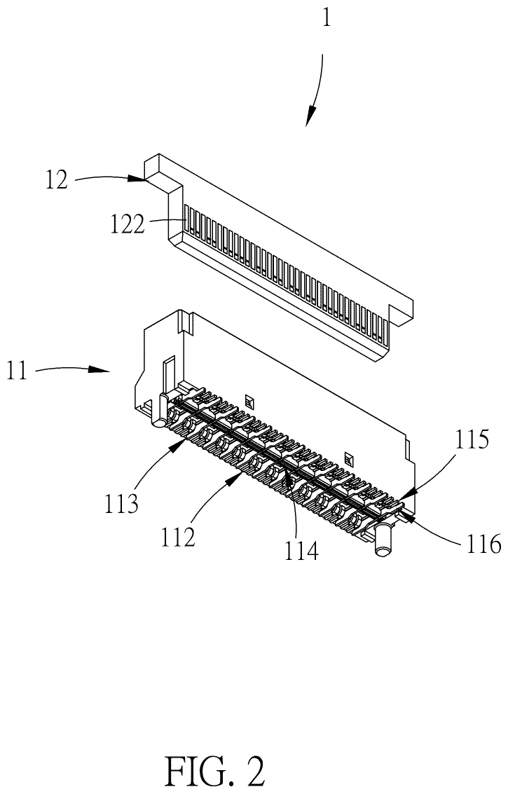

In the embodiment shown in FIGS. 1 to 2 of the present application, the connector assembly 1 comprises an electrical connector 11 and a mating conductive component 12.

In the above embodiment, the electrical connector 11 may optionally be a wire-end connector or a board-end connector. The electrical connector 11 comprises: a conductive plastic base 111, a major signal terminal module 112, a major grounding terminal module 113, a minor signal terminal module 115, a minor grounding terminal module 116, and a conductive metal shielding component 117. It should be noted that the conductive plastic base 111 may optionally be made of conductive plastic to provide electromagnetic wave absorption and/or electrical shielding. The conductive metal shielding component 117 may optionally be made of conductive metal to equipped with the conductive plastic base 111 to provide electromagnetic wave absorption and/or electrical shielding.

The conductive plastic base 111 comprises a first major conductive plastic base non-mating side shielding structure 1111, a second major conductive plastic base non-mating side shielding structure 1112, a first minor conductive plastic base non-mating side shielding structure 1114, and a second minor conductive plastic base non-mating side shielding structure 1115.

It should be noted that a major conductive plastic base signal terminal root shielding space SR1 is disposed between the first major conductive plastic base non-mating side shielding structure 1111 and the second major conductive plastic base non-mating side shielding structure 1112, and a major conductive plastic base signal terminal mating shielding space ST1 is also disposed between the first major conductive plastic base non-mating side shielding structure 1111 and the second major conductive plastic base non-mating side shielding structure 1112.

Furthermore, a minor conductive plastic base signal terminal root shielding space SR2 is disposed between the first minor conductive plastic base non-mating side shielding structure 1114 and the second minor conductive plastic base non-mating side shielding structure 1115, and a minor conductive plastic base signal terminal mating shielding space ST2 is also disposed between the first minor conductive plastic base non-mating side shielding structure 1114 and the second minor conductive plastic base non-mating side shielding structure 1115.

The conductive metal shielding component 117 comprises a major conductive metal shielding component signal terminal mating side shielding structure 1171 and a minor conductive metal shielding component signal terminal mating side shielding structure 1174. In the above embodiment, the conductive metal shielding component 117 comprises a U-shaped structure, wherein the major conductive metal shielding component signal terminal mating side shielding structure 1171 enters the major conductive plastic base signal terminal root shielding space SR1, and the minor conductive metal shielding component signal terminal mating side shielding structure 1174 enters the minor conductive plastic base signal terminal root shielding space SR2.

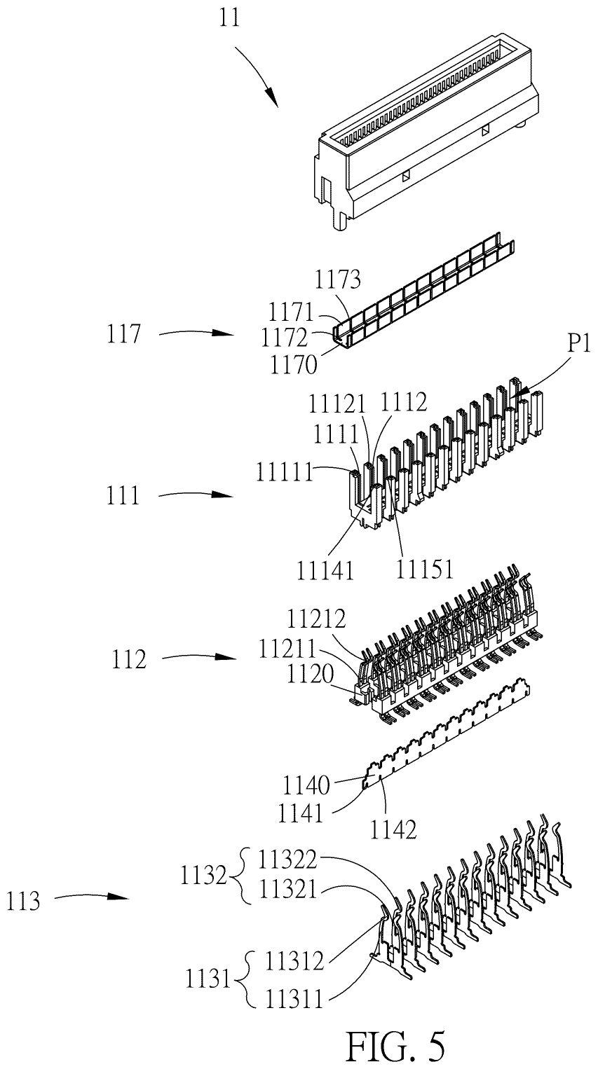

The major signal terminal module 112 comprises a major signal terminal 1121 and a major signal terminal insulation core 1120. The major signal terminal 1121 is provided for signal transmission. As shown in FIGS. 5, 11, 17, and 23, the major signal terminal 1121 comprises a major signal terminal root structure 11211 and a major signal terminal mating structure 11212. The major signal terminal root structure 11211 provides support for the major signal terminal mating structure 11212, and the major signal terminal mating structure 11212 enables mating with the mating conductive component 12.

It should be noted that the major signal terminal insulation core 1120 may optionally be made of an insulating material. In the above embodiment, the major signal terminal insulation core 1120 respectively positions the major signal terminal 1121 and the conductive plastic base 111 to position the major signal terminal 1121 in the conductive plastic base 111, avoid electrical connection between the major signal terminal 1121 and the conductive plastic base 111, and allow the major signal terminal root structure 11211 to enter the major conductive plastic base signal terminal root shielding space SR1, enabling the first major conductive plastic base non-mating side shielding structure 1111 and the second major conductive plastic base non-mating side shielding structure 1112 to respectively provide shielding for the major signal terminal root structure 11211 on a major non-mating side L11 of the major signal terminal 1121 to reduce interference during signal transmission of the major signal terminal root structure 11211, thereby meeting the signal transmission requirements of the electrical connector 11. Additionally, the major conductive metal shielding component signal terminal mating side shielding structure 1171 provides shielding for the major signal terminal root structure 11211 on a major mating side L12 of the major signal terminal 1121 to reduce interference during signal transmission of the major signal terminal root structure 11211, thereby meeting the signal transmission requirements of the electrical connector 11. Furthermore, the major signal terminal mating structure 11212 enters the major conductive plastic base signal terminal mating shielding space ST1, enabling the first major conductive plastic base non-mating side shielding structure 1111 and the second major conductive plastic base non-mating side shielding structure 1112 to respectively provide shielding for the major signal terminal mating structure 11212 on the major non-mating side L11 of the major signal terminal 1121 to reduce interference during signal transmission of the major signal terminal mating structure 11212, thereby meeting the signal transmission requirements of the electrical connector 11.

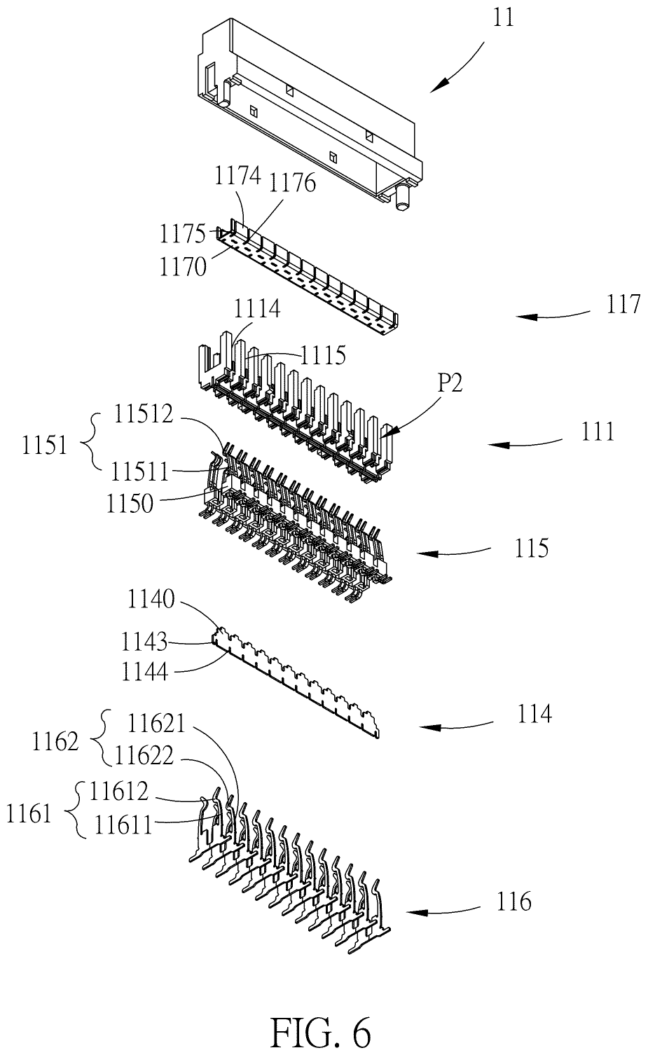

The minor signal terminal module 115 comprises a minor signal terminal 1151 and a minor signal terminal insulation core 1150. The minor signal terminal 1151 is provided for signal transmission. As shown in FIGS. 6, 11, 17 to 19, and 23, the minor signal terminal 1151 comprises a minor signal terminal root structure 11511 and a minor signal terminal mating structure 11512. The minor signal terminal root structure 11511 provides support for the minor signal terminal mating structure 11512, and the minor signal terminal mating structure 11512 enables mating with the mating conductive component 12.

It should be explained that the minor signal terminal insulation core 1150 may optionally be made of insulating material. In the above embodiment, the minor signal terminal insulation core 1150 respectively positions the minor signal terminal 1151 and the conductive plastic base 111 to position the minor signal terminal 1151 in the conductive plastic base 111 and to prevent the minor signal terminal 1151 from being electrically connected to the conductive plastic base 111. Furthermore, the minor signal terminal root structure 11511 enters the minor conductive plastic base signal terminal root shielding space SR2 so that the first minor conductive plastic base signal terminal non-mating side shielding structure 1114 and the second minor conductive plastic base signal terminal non-mating side shielding structure 1115 respectively provide shielding for the minor signal terminal root structure 11511 on the minor non-mating side L21 of the minor signal terminal 1151. This reduces the degree of signal transmission interference of the minor signal terminal root structure 11511, thereby meeting the signal transmission requirements of the electrical connector 11. Moreover, the minor conductive metal shielding component signal terminal mating side shielding structure 1174 provides shielding for the minor signal terminal root structure 11511 on the minor mating side L22 of the minor signal terminal 1151, reducing interference during signal transmission of the minor signal terminal root structure 11511 and satisfying the signal transmission requirements of the electrical connector 11. Additionally, the minor signal terminal mating structure 11512 enters the minor conductive plastic base signal terminal mating shielding space ST2, so that the first minor conductive plastic base signal terminal non-mating side shielding structure 1114 and the second minor conductive plastic base signal terminal non-mating side shielding structure 1115 provide shielding for the minor signal terminal mating structure 11512 on the minor non-mating side L21. This reduces the interference during signal transmission of the minor signal terminal mating structure 11512, thereby meeting the signal transmission requirements of the electrical connector 11.

In the above embodiment, the mating conductive component 12 may optionally be a mating connector, a mating circuit board, or a mating conductive body. The mating conductive component 12 comprises a major mating conductive component signal terminal mating structure 121 and a minor mating conductive component signal terminal mating structure 122. It should be explained that the mating conductive component 12 may mate with the electrical connector 11, such that the major mating conductive component signal terminal mating structure 121 mates with the major signal terminal mating structure 11212 in the major conductive plastic base signal terminal mating shielding space ST1, and the minor mating conductive component signal terminal mating structure 122 mates with the minor signal terminal mating structure 11512 in the minor conductive plastic base signal terminal mating shielding space ST2.

It should be explained that in the above embodiment, when the mating conductive component 12 mates with the electrical connector 11, the major mating conductive component signal terminal mating structure 121 is located on the major mating side L12 of the major signal terminal 1121, and the minor mating conductive component signal terminal mating structure 122 is located on the minor mating side L22.

The major grounding terminal module 113 comprises a first major grounding terminal 1131 and a second major grounding terminal 1132. The first major grounding terminal 1131 comprises a first major grounding terminal root structure 11311 and a first major grounding terminal mating structure 11312, wherein the first major grounding terminal root structure 11311 provides support for the first major grounding terminal mating structure 11312, and the first major grounding terminal mating structure 11312 provides mating with the mating conductive component 12. The second major grounding terminal 1132 comprises a second major grounding terminal root structure 11321 and a second major grounding terminal mating structure 11322, wherein the second major grounding terminal root structure 11321 provides support for the second major grounding terminal mating structure 11322, and the second major grounding terminal mating structure 11322 provides mating with the mating conductive component 12.

It should be explained that in the above embodiment, the first major grounding terminal 1131 and the second major grounding terminal 1132 are respectively positioned by the conductive plastic base 111, such that the first major grounding terminal root structure 11311 and the second major grounding terminal root structure 11321 respectively enter the major conductive plastic base signal terminal root shielding space SR1. This ensures that the first major grounding terminal root structure 11311 and the second major grounding terminal root structure 11321 provide shielding for the major signal terminal root structure 11211 on the major non-mating side L11, reducing the degree of signal transmission interference of the major signal terminal root structure 11211, thereby meeting the signal transmission requirements of the electrical connector 11. Additionally, the first major grounding terminal mating structure 11312 and the second major grounding terminal mating structure 11322 enter the major conductive plastic base signal terminal mating shielding space ST1, ensuring that the first major grounding terminal mating structure 11312 and the second major grounding terminal mating structure 11322 provide shielding for the major signal terminal mating structure 11212 on the major non-mating side L11, reducing interference during signal transmission of the major signal terminal mating structure 11212, thereby meeting the signal transmission requirements of the electrical connector 11.

Optionally, in the embodiments shown in FIGS. 5, 10, and 20 of this application, the first major grounding terminal 1131 is positioned by the first major conductive plastic base signal terminal non-mating side shielding structure 1111, and the second major grounding terminal 1132 is positioned by the second major conductive plastic base signal terminal non-mating side shielding structure 1112, positioning the first major grounding terminal 1131 and the second major grounding terminal 1132 in the conductive plastic base 111. This allows the first major grounding terminal 1131 and the second major grounding terminal 1132 to electrically connect to the conductive plastic base 111 and transmit grounding signals.

The minor grounding terminal module 116 comprises a first minor grounding terminal 1161 and a second minor grounding terminal 1162. The first minor grounding terminal 1161 comprises a first minor grounding terminal root structure 11611 and a first minor grounding terminal mating structure 11612, wherein the first minor grounding terminal root structure 11611 provides support for the first minor grounding terminal mating structure 11612, and the first minor grounding terminal mating structure 11612 provides mating with the mating conductive component 12. The second minor grounding terminal 1162 comprises a second minor grounding terminal root structure 11621 and a second minor grounding terminal mating structure 11622, wherein the second minor grounding terminal root structure 11621 provides support for the second minor grounding terminal mating structure 11622, and the second minor grounding terminal mating structure 11622 provides mating with the mating conductive component 12.

It should be explained that in the above embodiment, the first minor grounding terminal 1161 and the second minor grounding terminal 1162 are respectively positioned by the conductive plastic base 111, such that the first minor grounding terminal root structure 11611 and the second minor grounding terminal root structure 11621 respectively enter the minor conductive plastic base signal terminal root shielding space SR2. This ensures that the first minor grounding terminal root structure 11611 and the second minor grounding terminal root structure 11621 provide shielding for the minor signal terminal root structure 11511 on the minor non-mating side L21, reducing the degree of signal transmission interference of the minor signal terminal root structure 11511, thereby meeting the signal transmission requirements of the electrical connector 11. Additionally, the first minor grounding terminal mating structure 11612 and the second minor grounding terminal mating structure 11622 enter the minor conductive plastic base signal terminal mating shielding space ST2, ensuring that the first minor grounding terminal mating structure 11612 and the second minor grounding terminal mating structure 11622 provide shielding for the minor signal terminal mating structure 11512 on the minor non-mating side L21, reducing interference during signal transmission of the minor signal terminal mating structure 11512, thereby meeting the signal transmission requirements of the electrical connector 11.

Optionally, in the embodiments shown in FIGS. 6, 10, and 20 of this application, the first minor grounding terminal 1161 is positioned by the first minor conductive plastic base signal terminal non-mating side shielding structure 1114, and the second minor grounding terminal 1162 is positioned by the second minor conductive plastic base signal terminal non-mating side shielding structure 1115, so as to position the first minor grounding terminal 1161 and the second minor grounding terminal 1162 in the conductive plastic base 111. Furthermore, the first minor grounding terminal 1161 and the second minor grounding terminal 1162 are electrically connected to the conductive plastic base 111 for transmitting grounding signals.

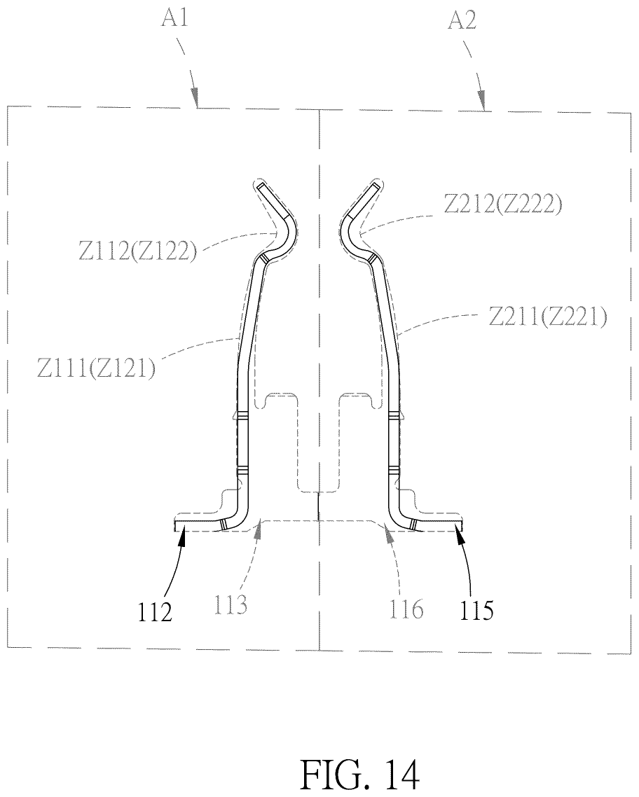

In the embodiment shown in FIG. 14 of this application, the major signal terminal 1121 is projected on a major signal terminal projection plane A1. The projections of the first major grounding terminal root structure 11311 on the major signal terminal projection plane A1 is in a first major grounding terminal root structure projection area Z111, and the second major grounding terminal root structure 11321 on the major signal terminal projection plane A1 is in a second major grounding terminal root structure projection area Z121. The major signal terminal root structure 11211 is projected in the first major grounding terminal root structure projection area Z111 and the second major grounding terminal root structure projection area Z121. Thus, the first major grounding terminal root structure 11311 and the second major grounding terminal root structure 11321 provide shielding for the major signal terminal root structure 11211, reducing the degree of interference in signal transmission of the major signal terminal root structure 11211, thereby meeting the signal transmission requirements of the electrical connector 11. Additionally, the projections of the first major grounding terminal mating structure 11312 on the major signal terminal projection plane A1 is in a first major grounding terminal mating structure projection area Z112, and the second major grounding terminal mating structure 11322 on the major signal terminal projection plane A1 is in a second major grounding terminal mating structure projection area Z122. The major signal terminal mating structure 11212 is projected in the first major grounding terminal mating structure projection area Z112 and the second major grounding terminal mating structure projection area Z122. Thus, the first major grounding terminal mating structure 11312 and the second major grounding terminal mating structure 11322 provide shielding for the major signal terminal mating structure 11212, reducing the degree of interference in signal transmission of the major signal terminal mating structure 11212, thereby meeting the signal transmission requirements of the electrical connector 11.

Additionally, the first minor grounding terminal 1161 is projected on a minor signal terminal projection plane A2. The projections of the first minor grounding terminal root structure 11611 on the minor signal terminal projection plane A2 is in a first minor grounding terminal root structure projection area Z211, and the second minor grounding terminal root structure 11621 on the minor signal terminal projection plane A2 is in a second minor grounding terminal root structure projection area Z221. The minor signal terminal root structure 11511 is projected in the first minor grounding terminal root structure projection area Z211 and the second minor grounding terminal root structure projection area Z221. Thus, the first minor grounding terminal root structure 11611 and the second minor grounding terminal root structure 11621 provide shielding for the minor signal terminal root structure 11511, reducing the degree of interference in signal transmission of the minor signal terminal root structure 11511, thereby meeting the signal transmission requirements of the electrical connector 11. Additionally, the projections of the first minor grounding terminal mating structure 11612 on the minor signal terminal projection plane A2 is in a first minor grounding terminal mating structure projection area Z212, and the second minor grounding terminal mating structure 11622 on the minor signal terminal projection plane A2 is a second minor grounding terminal mating structure projection area Z222. The minor signal terminal mating structure 11512 is projected in the first minor grounding terminal mating structure projection area Z212 and the second minor grounding terminal mating structure projection area Z222. Thus, the first minor grounding terminal mating structure 11612 and the second minor grounding terminal mating structure 11622 provide shielding for the minor signal terminal mating structure 11512, reducing the degree of interference in signal transmission of the minor signal terminal mating structure 11512, thereby meeting the signal transmission requirements of the electrical connector 11.

In the embodiments shown in FIGS. 5, 10, and 17 to 20 of this application, the first major conductive plastic base signal terminal non-mating side shielding structure 1111 comprises a first major conductive plastic base grounding terminal penetrating passage 11111, and the second major conductive plastic base signal terminal non-mating side shielding structure 1112 comprises a second major conductive plastic base grounding terminal penetrating passage 11121. The first major conductive plastic base grounding terminal penetrating passage 11111 is configured to allow the first major grounding terminal 1131 to pass through, and the second major conductive plastic base grounding terminal penetrating passage 11121 is configured to allow the second major grounding terminal 1132 to pass through, to prevent the first major conductive plastic base signal terminal non-mating side shielding structure 1111 from interfering with the first major grounding terminal 1131, and to prevent the second major conductive plastic base signal terminal non-mating side shielding structure 1112 from interfering with the second major grounding terminal 1132, thereby avoiding any adverse impact on the mating of the first major grounding terminal mating structure 11312 and the second major grounding terminal mating structure 11322 with the mating conductive component 12.

Additionally, the first minor conductive plastic base signal terminal non-mating side shielding structure 1114 is provided with a first minor conductive plastic base grounding terminal penetrating passage 11141, and the second minor conductive plastic base signal terminal non-mating side shielding structure 1115 is provided with a second minor conductive plastic base grounding terminal penetrating passage 11151. The first minor conductive plastic base grounding terminal penetrating passage 11141 is configured to allow the first minor grounding terminal 1161 to pass through, and the second minor conductive plastic base grounding terminal penetrating passage 11151 is configured to allow the second minor grounding terminal 1162 to pass through, to prevent the first minor conductive plastic base signal terminal non-mating side shielding structure 1114 from interfering with the first minor grounding terminal 1161, and to prevent the second minor conductive plastic base signal terminal non-mating side shielding structure 1115 from interfering with the second minor grounding terminal 1162, thereby avoiding any adverse impact on the mating of the first minor grounding terminal mating structure 11612 and the second minor grounding terminal mating structure 11622 with the mating conductive component 12.

In the embodiments shown in FIGS. 5 to 6, 13, and 17 of this application, the conductive plastic base 111 further comprises a major conductive plastic base signal terminal penetrating passage P1 and a minor conductive plastic base signal terminal penetrating passage P2.

It should be noted that the major conductive plastic base signal terminal penetrating passage P1 is located between the first major conductive plastic base signal terminal non-mating side shielding structure 1111 and the second major conductive plastic base signal terminal non-mating side shielding structure 1112 to allow the major signal terminal 1121 to pass through, thereby preventing the conductive plastic base 111 from interfering with the major signal terminal 1121 and affecting the mating of the major signal terminal mating structure 11212 with the mating conductive component 12. In the above-mentioned embodiments, the major conductive metal shielding component signal terminal mating side shielding structure 1171 provides shielding on the major mating side L12 for the major conductive plastic base signal terminal penetrating passage P1, reducing the degree of interference in signal transmission of the major signal terminal 1121, thereby meeting the signal transmission requirements of the electrical connector 11.

Additionally, the minor conductive plastic base signal terminal penetrating passage P2 is positioned between the first minor conductive plastic base signal terminal non-mating side shielding structure 1114 and the second minor conductive plastic base signal terminal non-mating side shielding structure 1115, enabling the penetrating of the minor signal terminal 1151 while avoiding interference with the conductive plastic base 111. This ensures that the minor signal terminal mating structure 11512 can mate with the mating conductive component 12 without obstruction. In the aforementioned embodiment, the minor conductive metal shielding component signal terminal mating side shielding structure 1174 provides shielding for the minor conductive plastic base signal terminal penetrating passage P2 on the minor mating side L22. This reduces the interference affecting the signal transmission of the minor signal terminal 1151 and satisfies the signal transmission requirements of the electrical connector 11.

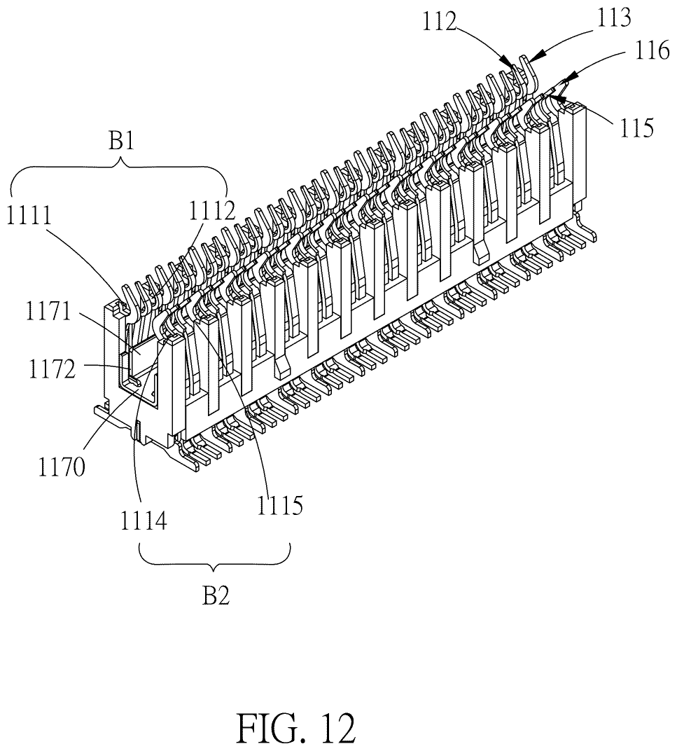

In the embodiments illustrated in FIGS. 12 to 13 and FIGS. 15 to 16 of this application, the first major conductive plastic base signal terminal non-mating side shielding structure 1111 and the second major conductive plastic base signal terminal non-mating side shielding structure 1112 form a major conductive plastic base signal terminal shielding structure B1 for signal transmission. Additionally, the first minor conductive plastic base signal terminal non-mating side shielding structure 1114 and the second minor conductive plastic base signal terminal non-mating side shielding structure 1115 form a minor conductive plastic base signal terminal shielding structure B2 for signal transmission.

In the embodiments illustrated in FIGS. 5 to 6, FIG. 8, and FIGS. 18 of this application, a bridging conductive component 114 is further comprised. The bridging conductive component 114 may optionally be made of conductive metal or conductive plastic. The bridging conductive component 114 comprises a bridging conductive component body 1140, a first major bridging conductive component mating structure 1141, a second major bridging conductive component mating structure 1142, a first minor bridging conductive component mating structure 1143, and a second minor bridging conductive component mating structure 1144.

It should be noted that the bridging conductive component 114 engages with the conductive plastic base 111, thereby positioning the bridging conductive component 114 on the conductive plastic base 111 and electrically connecting the bridging conductive component 114 with the conductive plastic base 111 for signal transmission. Moreover, the bridging conductive component body 1140 spans over the major signal terminal 1121 and the minor signal terminal 1151, enabling the first major bridging conductive component mating structure 1141 o mate with the first major grounding terminal 1131, and enabling the second major bridging conductive component mating structure 1142 to mate with the second major grounding terminal 1132. This establishes an electrical connection between the bridging conductive component body 1140, the first major grounding terminal 1131, and the second major grounding terminal 1132 for grounding signal transmission. Additionally, the first minor bridging conductive component mating structure 1143 mates with the first minor grounding terminal 1161, and the second minor bridging conductive component mating structure 1144 mates with the first minor grounding terminal 1161 and the second minor grounding terminal 1162. This establishes an electrical connection between the bridging conductive component body 1140, the first minor grounding terminal 1161, and the second minor grounding terminal 1162 for grounding signal transmission.

In the aforementioned embodiments, the bridging conductive component body 1140 is located between the major signal terminal module 112 and the minor signal terminal module 115, thereby simplifying the manufacturing process of the electrical connector 11.

In the embodiments illustrated in FIGS. 5 to 6, FIG. 8, FIGS. 10 to 12, FIGS. 19 to 20, and FIG. 23 of this application, the conductive metal shielding component 117 further comprises a conductive metal shielding component body 1170. The conductive metal shielding component body 1170 spans over both the major signal terminal 1121 and the minor signal terminal 1151, and is respectively mated with the bridging conductive component body 1140, the first major grounding terminal 1131, the second major grounding terminal 1132, the first minor grounding terminal 1161, and the second minor grounding terminal 1162. This establishes an electrical connection between the conductive metal shielding component body 1170, the bridging conductive component body 1140, the first major grounding terminal 1131, the second major grounding terminal 1132, the first minor grounding terminal 1161, and the second minor grounding terminal 1162 for grounding signal transmission.

It should be noted that, in the embodiments of this application, some of the aforementioned components may be omitted. For example, the electrical connector may optionally comprise only the conductive plastic base, the conductive metal shielding component, and the major signal terminal module. The conductive plastic base comprises a first major conductive plastic base signal terminal non-mating side shielding structure and a second major conductive plastic base signal terminal non-mating side shielding structure. Between the first major conductive plastic base signal terminal non-mating side shielding structure and second major conductive plastic base signal terminal non-mating side shielding structure is a major conductive plastic base signal terminal root shielding space, as well as a major conductive plastic base signal terminal mating shielding space. The conductive metal shielding component is paired with the conductive plastic base and comprises a major conductive metal shielding component signal terminal mating side shielding structure, which enters the major conductive plastic base signal terminal root shielding space. The major signal terminal module comprises major signal terminals and the major signal terminal insulation cores. Each major signal terminal comprises a major signal terminal root structure and a major signal terminal mating structure, with the major signal terminal root structure providing support for the major signal terminal mating structure. The major signal terminal insulation core respectively positions the major signal terminal and the conductive plastic base, allowing the major signal terminal root structure to enter the major conductive plastic base signal terminal root shielding space. Consequently, the first major conductive plastic base signal terminal non-mating side shielding structure and second major conductive plastic base signal terminal non-mating side shielding structure respectively provide shielding for the major signal terminal root structure on the major non-mating side of the major signal terminal, while the major conductive metal shielding component signal terminal mating side shielding structure provides shielding for the major signal terminal root structure on the major mating side of the major signal terminal,. Additionally, the major signal terminal mating structure enters the major conductive plastic base signal terminal mating shielding space, enabling the first major conductive plastic base signal terminal non-mating side shielding structure and second major conductive plastic base signal terminal non-mating side shielding structure to respectively provide shielding for the major signal terminal mating structure on the major non-mating side.

Furthermore, the connector assembly may optionally comprise only the electrical connector and the mating conductive component. The mating conductive component comprises a major mating conductive component signal terminal mating structure and can mate with the electrical connector. The major mating conductive component signal terminal mating structure mates with the major signal terminal mating structure in the major conductive plastic base signal terminal mating shielding space. When the mating conductive component mates with the electrical connector, the major mating conductive component signal terminal mating structure is located on the major mating side.

In summary, this application provides a connector assembly and electrical connector thereof. The electrical connector can mate with a mating conductive component and comprises a conductive plastic base, a conductive metal shielding component, and a signal terminal. The signal terminal mates with the mating conductive component for signal transmission, while the conductive plastic base and the conductive metal shielding component provide shielding for the signal terminal. This reduces the interference affecting the signal transmission of the signal terminal and satisfies the signal transmission requirements of the electrical connector.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as define by the appended claims.

1. An electrical connector, the electrical connector comprising:
a conductive plastic base, the conductive plastic base comprising a first major conductive plastic base signal terminal non-mating side shielding structure and a second major conductive plastic base signal terminal non-mating side shielding structure, wherein a major conductive plastic base signal terminal root shielding space is formed between the first major conductive plastic base signal terminal non-mating side shielding structure and the second major conductive plastic base signal terminal non-mating side shielding structure, and a major conductive plastic base signal terminal mating shielding space is formed between the first major conductive plastic base signal terminal non-mating side shielding structure and the second major conductive plastic base signal terminal non-mating side shielding structure;
a conductive metal shielding component, the conductive metal shielding component equipped with the conductive plastic base, the conductive metal shielding component comprising a major conductive metal shielding component signal terminal mating side shielding structure, and the major conductive metal shielding component signal terminal mating side shielding structure entering the major conductive plastic base signal terminal root shielding space; and
a major signal terminal module, the major signal terminal module comprising a major signal terminal and a major signal terminal insulation core, wherein the major signal terminal comprises a major signal terminal root structure and a major signal terminal mating structure, the major signal terminal root structure providing support for the major signal terminal mating structure, and the major signal terminal insulation core respectively position the major signal terminal and the conductive plastic base, such that the major signal terminal root structure enters the major conductive plastic base signal terminal root shielding space, allowing the first major conductive plastic base signal terminal non-mating side shielding structure and the second major conductive plastic base signal terminal non-mating side shielding structure to respectively provide shielding for the major signal terminal root structure on a major non-mating side of the major signal terminal, and allowing the major conductive metal shielding component signal terminal mating side shielding structure provides shielding for the major signal terminal root structure on a major mating side of the major signal terminal, enabling the major signal terminal mating structure to enter the major conductive plastic base signal terminal mating shielding space, allowing the first major conductive plastic base signal terminal non-mating side shielding structure and the second major conductive plastic base signal terminal non-mating side shielding structure to respectively provide shielding for the major signal terminal mating structure on the major non-mating side.

2. The electrical connector of claim 1, wherein the conductive plastic base further comprises a major conductive plastic base signal terminal penetrating passage, the major conductive plastic base signal terminal penetrating passage being located between the first major conductive plastic base signal terminal non-mating side shielding structure and the second major conductive plastic base signal terminal non-mating side shielding structure to allow the major signal terminal to pass through, thereby preventing the conductive plastic base from interfering with the major signal terminal.

3. The electrical connector of claim 2, wherein the major conductive metal shielding component signal terminal mating side shielding structure provides shielding for the major conductive plastic base signal terminal penetrating passage on the major mating side.

4. The electrical connector of claim 1, further comprising a major grounding terminal module, the major grounding terminal module comprising a first major grounding terminal and a second major grounding terminal, wherein the first major grounding terminal comprises a first major grounding terminal root structure and a first major grounding terminal mating structure, and the first major grounding terminal root structure provides support for the first major grounding terminal mating structure, and the second major grounding terminal comprises a second major grounding terminal root structure and a second major grounding terminal mating structure, and the second major grounding terminal root structure provides support for the second major grounding terminal mating structure, and the first major grounding terminal and the second major grounding terminal are respectively positioned by the conductive plastic base, such that the first major grounding terminal root structure and the second major grounding terminal root structure enter the major conductive plastic base signal terminal root shielding space, allowing the first major grounding terminal root structure and the second major grounding terminal root structure to respectively provide shielding for the major signal terminal root structure on the major non-mating side, and the first major grounding terminal mating structure and the second major grounding terminal mating structure respectively enter the major conductive plastic base signal terminal mating shielding space, allowing the first major grounding terminal mating structure and the second major grounding terminal mating structure to respectively provide shielding for the major signal terminal mating structure on the major non-mating side.

5. The electrical connector of claim 4, wherein the first major grounding terminal is positioned by the first major conductive plastic base signal terminal non-mating side shielding structure, and the second major grounding terminal is positioned by the second major conductive plastic base signal terminal non-mating side shielding structure.

6. The electrical connector of claim 4, wherein the conductive metal shielding component further comprises a first major conductive metal shielding component grounding terminal penetrating passage and a second major conductive metal shielding component grounding terminal penetrating passage, the first major conductive metal shielding component grounding terminal penetrating passage allowing the first major grounding terminal to pass through, and the second major conductive metal shielding component grounding terminal penetrating passage allowing the second major grounding terminal to pass through, thereby preventing the conductive metal shielding component from interfering with the first major grounding terminal and the second major grounding terminal.

7. The electrical connector of claim 4, wherein the conductive metal shielding component further comprises a conductive metal shielding component body, the conductive metal shielding component body spanning across the major signal terminal and respectively positioning the first second major grounding terminal and the second major grounding terminal, enabling the conductive metal shielding component body to electrically connect the first major grounding terminal and the second major grounding terminal.

8. The electrical connector of claim 4, wherein the first major conductive plastic base signal terminal non-mating side shielding structure comprises a first major conductive plastic base grounding terminal penetrating passage, and the second major conductive plastic base signal terminal non-mating side shielding structure comprises a second major conductive plastic base grounding terminal penetrating passage, and the first major conductive plastic base grounding terminal penetrating passage allows the first major grounding terminal to pass through, and the second major conductive plastic base grounding terminal penetrating passage allows the second major grounding terminal to pass through, thereby preventing the first second major conductive plastic base signal terminal non-mating side shielding structure from interfering with the first major grounding terminal, and preventing the second major conductive plastic base signal terminal non-mating side shielding structure from interfering with the second major grounding terminal.

9. The electrical connector of claim 4, wherein the major signal terminal is projected on a major signal terminal projection plane, the projection of the first major grounding terminal root structure on the major signal terminal projection plane is in a first major grounding terminal root structure projection area, and the projection of the second major grounding terminal root structure on the major signal terminal projection plane is in a second major grounding terminal root structure projection area, and the major signal terminal root structure is projected in the first major grounding terminal root structure projection area and the second major grounding terminal root structure projection area; and the projection of the first major grounding terminal mating structure on the major signal terminal projection plane is in a first major grounding terminal mating structure projection area, and the projection of the second major grounding terminal mating structure on the major signal terminal projection plane is in a second major grounding terminal mating structure projection area, and the major signal terminal mating structure is projected in the first major grounding terminal mating structure projection area and the second major grounding terminal mating structure projection area.

10. The electrical connector of claim 4, further comprising a bridging conductive component, wherein the bridging conductive component comprises a bridging conductive component body, a first major bridging conductive component joining structure, and a second major bridging conductive component joining structure, the bridging conductive component being positioned by the conductive plastic base such that the bridging conductive component body spans across the major signal terminal, and the first major bridging conductive component joining structure is joined to the first major grounding terminal, and the second major bridging conductive component joining structure is joined to the second major grounding terminal, thereby the bridging conductive component body electrically connecting the first major grounding terminal and the second major grounding terminal.

11. The electrical connector of claim 10, wherein the conductive metal shielding component further comprises a conductive metal shielding component body, and the conductive metal shielding component body spans across the major signal terminal and is positioned by the bridging conductive component body, thereby electrically connecting the conductive metal shielding component body to the bridging conductive component body.

12. The electrical connector of claim 1, wherein
the conductive plastic base further comprises a first minor conductive plastic base signal terminal non-mating side shielding structure and a second minor conductive plastic base signal terminal non-mating side shielding structure, wherein a minor conductive plastic base signal terminal root shielding space is provided between the first minor conductive plastic base signal terminal non-mating side shielding structure and the second minor conductive plastic base signal terminal non-mating side shielding structure, and a minor conductive plastic base signal terminal mating shielding space is provided between the first minor conductive plastic base signal terminal non-mating side shielding structure and the second minor conductive plastic base signal terminal non-mating side shielding structure;
the conductive metal shielding component further comprises a minor conductive metal shielding component signal terminal mating side shielding structure, the minor conductive metal shielding component signal terminal mating side shielding structure entering the minor conductive plastic base signal terminal root shielding space; and
the electrical connector further comprises:
a minor signal terminal module, wherein the minor signal terminal module comprises a minor signal terminal and a minor signal terminal insulation core, the minor signal terminal comprising a minor signal terminal root structure and a minor signal terminal mating structure, the minor signal terminal root structure providing support for the minor signal terminal mating structure, and the minor signal terminal insulation core respectively positions the minor signal terminal and the conductive plastic base such that the minor signal terminal root structure enters the minor conductive plastic base signal terminal root shielding space, causing the first minor conductive plastic base signal terminal non-mating side shielding structure and the second minor conductive plastic base signal terminal non-mating side shielding structure to respectively provide shielding for the minor signal terminal root structure on a non-mating side of the minor signal terminal, and causing the minor conductive metal shielding component signal terminal mating side shielding structure to provide shielding for the minor signal terminal root structure on a minor mating side of the minor signal terminal, while also allowing the minor signal terminal mating structure to enter the minor conductive plastic base signal terminal mating shielding space, so that the first minor conductive plastic base signal terminal non-mating side shielding structure and the second minor conductive plastic base signal terminal non-mating side shielding structure respectively provide shielding for the minor signal terminal mating structure on the minor non-mating side.

13. The electrical connector of claim 12, wherein the conductive plastic base further comprises a minor conductive plastic base signal terminal penetrating passage, and the minor conductive plastic base signal terminal penetrating passage is located between the first minor conductive plastic base signal terminal non-mating side shielding structure and the second minor conductive plastic base signal terminal non-mating side shielding structure for the minor signal terminal to pass through, while preventing interference with the minor signal terminal by the conductive plastic base.

14. The electrical connector of claim 13, wherein the minor conductive metal shielding component signal terminal mating side shielding structure provides shielding for the minor conductive plastic base signal terminal penetrating passage on the minor mating side.

15. The electrical connector of claim 12, further comprising a minor grounding terminal module, wherein the minor grounding terminal module comprises a first minor grounding terminal and a second minor grounding terminal, the first minor grounding terminal comprising a first minor grounding terminal root structure and a first minor grounding terminal mating structure, the first minor grounding terminal root structure providing support for the first minor grounding terminal mating structure, the second minor grounding terminal comprising a second minor grounding terminal root structure and a second minor grounding terminal mating structure, the second minor grounding terminal root structure providing support for the second minor grounding terminal mating structure, and the first minor grounding terminal and the second minor grounding terminal being positioned by the conductive plastic base such that the first minor grounding terminal root structure and the second minor grounding terminal root structure respectively enter the minor conductive plastic base signal terminal root shielding space, thereby causing the first minor grounding terminal root structure and the second minor grounding terminal root structure to respectively provide shielding for the minor signal terminal root structure on the minor non-mating side, and causing the first minor grounding terminal mating structure and the second minor grounding terminal mating structure to respectively enter the minor conductive plastic base signal terminal mating shielding space, thereby causing the first minor grounding terminal mating structure and the second minor grounding terminal mating structure to respectively provide shielding for the minor signal terminal mating structure on the minor non-mating side.

16. The electrical connector of claim 15, wherein the first minor grounding terminal is positioned by the first minor conductive plastic base signal terminal non-mating side shielding structure and the second minor grounding terminal is positioned by the second minor conductive plastic base signal terminal non-mating side shielding structure.

17. The electrical connector of claim 15, wherein the conductive metal shielding component further comprises a first major conductive metal shielding component grounding terminal penetrating passage and a second major conductive metal shielding component grounding terminal penetrating passage, wherein the first major conductive metal shielding component grounding terminal penetrating passage is provided for the first grounding terminal to pass through, and the second major conductive metal shielding component grounding terminal penetrating passage is provided for the second grounding terminal to pass through, in order to prevent the conductive metal shielding component from interfering with the first grounding terminal and the second grounding terminal.

18. The electrical connector of claim 15, wherein the conductive metal shielding component further comprises a conductive metal shielding component body, wherein the conductive metal shielding component body spans across the minor signal terminal and respectively positions the first grounding terminal and the second grounding terminal, such that the conductive metal shielding component body electrically connects the first grounding terminal and the second grounding terminal.

19. The electrical connector of claim 15, wherein the first major conductive plastic base signal terminal non-mating side shielding structure comprises a first major conductive plastic base grounding terminal penetrating passage, and the second major conductive plastic base signal terminal non-mating side shielding structure comprises a second major conductive plastic base grounding terminal penetrating passage, wherein the first major conductive plastic base grounding terminal penetrating passage is provided for the first grounding terminal to pass through, and the second major conductive plastic base grounding terminal penetrating passage is provided for the second grounding terminal to pass through, in order to prevent the first major conductive plastic base signal terminal non-mating side shielding structure from interfering with the first grounding terminal, and to prevent the second major conductive plastic base signal terminal non-mating side shielding structure from interfering with the second grounding terminal.

20. The electrical connector of claim 15, wherein the minor grounding terminal is projected on a minor signal terminal projection plane, the projection of the first minor grounding terminal root structure on the minor signal terminal projection plane is in a first minor grounding terminal root structure projection area, and the projection of the second minor grounding terminal root structure on the minor signal terminal projection plane is in a second minor grounding terminal root structure projection area, and the minor signal terminal root structure is projected in the first minor grounding terminal root structure projection area and the second minor grounding terminal root structure projection area; and the projection of the first minor grounding terminal mating structure on the minor signal terminal projection plane is in a first minor grounding terminal mating structure projection area, and the projection of the second minor grounding terminal mating structure on the minor signal terminal projection plane is in a second minor grounding terminal mating structure projection area, and the minor signal terminal mating structure is projected in the first minor grounding terminal mating structure projection area and the second minor grounding terminal mating structure projection area.

21. The electrical connector of claim 15, further comprising a bridging conductive component, wherein the bridging conductive component comprises a bridging conductive component body, a first minor bridging conductive component joining structure, and a second minor bridging conductive component joining structure, the bridging conductive component being positioned by the conductive plastic base such that the bridging conductive component body spans across the minor signal terminal, and the first minor bridging conductive component joining structure is joined to the first minor grounding terminal, and the second minor bridging conductive component joining structure is joined to the second minor grounding terminal, thereby the bridging conductive component body electrically connecting the first minor grounding terminal and the second minor grounding terminal.

22. The electrical connector of claim 21, wherein the bridging conductive component body is located between the major signal terminal module and the minor signal terminal module.

23. The electrical connector of claim 21, wherein the conductive metal shielding component further comprises a conductive metal shielding component body, wherein the conductive metal shielding component body spans across the minor signal terminal module and is positioned by the bridging conductive component body, such that the conductive metal shielding component body electrically connects the bridging conductive component body.

24. A connector assembly, the connector assembly comprising:
the electrical connector of claim 1; and
a mating conductive component, the mating conductive component comprising a major mating conductive component signal terminal mating structure, wherein the mating conductive component is matable with the electrical connector, such that the major mating conductive component signal terminal mating structure mates with the major signal terminal mating structure in the major conductive plastic base signal terminal mating shielding space, wherein, when the mating conductive component mates with the electrical connector, the major mating conductive component signal terminal mating structure is located on the major mating side.

25. A connector assembly, the connector assembly comprising:
the electrical connector of claim 12; and
a mating conductive component, the mating conductive component comprising a major mating conductive component signal terminal mating structure and a minor mating conductive component signal terminal mating structure, wherein the mating conductive component is matable with the electrical connector, such that the major mating conductive component signal terminal mating structure mates with the major signal terminal mating structure in the major conductive plastic base signal terminal mating shielding space, and the minor mating conductive component signal terminal mating structure mates with the minor signal terminal mating structure in the minor conductive plastic base signal terminal mating shielding space, wherein, when the mating conductive component mates with the electrical connector, the major mating conductive component signal terminal mating structure is located on the major mating side of the major signal terminal, and the minor mating conductive component signal terminal mating structure is located on the minor mating side of the minor signal terminal.
